(19) United States
(12) Patent Application Publication
(10) Pub. No.: US 2009/0064172 A1
(43) Pub. Date: Mar. 5, 2009

(54) SYSTEM AND METHOD FOR TASK SCHEDULING

(75) Inventors: CHUNG-I LEE, Tu-Cheng (TW); CHIEN-FA YEH, Tu-Cheng (TW); DA-PENG LI, Shenzhen City (CN); ZHI-HONG LI, Shenzhen City (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/189,122

(22) Filed: Aug. 8, 2008

(30) Foreign Application Priority Data
Aug. 31, 2007 (CN) 200710201568.X

(51) Int. Cl. G06F 9/46

(52) U.S. Cl. 718/106

(57) ABSTRACT

A computer-based method for task scheduling is disclosed. The method includes: scheduling one or more scheduled tasks, creating a scheduled task list which contains the one or more scheduled tasks, reading parameters of each of the scheduled tasks, comparing the current tasks in the memory with the scheduled tasks in the scheduled task list according to the unique task IDs if the memory contains current tasks, adding the scheduled tasks that are present in the scheduled task lists and not in the memory into the memory, and removing the current tasks that are present in the memory and not present in the scheduled task lists according to the comparison.

### BACKGROUND OF THE INVENTION

1. Field of the Invention

Embodiments of the present disclosure relates to systems and methods for managing scheduled tasks, and particularly to a system and method for task scheduling.

2. Description of Related Art

Application software may be used to perform a task for general purpose, or for a specific purpose. The task is a set of electronic instructions that is loaded into memory of a computing system. Generally, users often schedule many tasks for many purposes. Sometimes the scheduled tasks need to be adjusted or modified, such as changing a time for backing up system drive at 11:00 am to 12:00 am. However, updating tasks are usually done manually, which inevitably result in error.

What is needed, therefore, is a system and method for task scheduling.

### SUMMARY

A system for task scheduling is provided. The system includes a setting module, a creating module, a reading module, a determining module, a comparing module, a comparing module, an updating module, and a processor. The setting module is configured for scheduling one or more scheduled tasks, the one or more scheduled tasks each comprising one or more parameters, the parameters comprising a unique task ID of a scheduled task. The creating module is configured for creating a scheduled task list that comprising the one or more scheduled tasks. The reading module is configured for reading the parameters for each of the scheduled tasks. The determining module configured for detecting if a memory of the system contains any current tasks. The comparing module is configured for comparing the current tasks in the memory with the scheduled tasks in the scheduled task list according to the unique task IDs upon the condition that the memory contains current tasks. The updating module is configured for adding the scheduled tasks that are present in the scheduled task lists and not in the memory into the memory, and removing the current tasks that are present in the memory and not present in the scheduled task lists according to the comparison. The processor that executes the setting module, the creating module, the reading module, the determining module, the comparing module, and the updating module.

Other objects, advantages and novel features will become more apparent from the following detailed description of certain embodiments of the present disclosure when taken in conjunction with the accompanying drawings, in which:

### BRIEF DESCRIPTION OF THE DRAWINGS

FIG. 1 is a block diagram of hardware configuration of a system for task scheduling in accordance with one embodiment of the present disclosure;

FIG. 2 is a block diagram of one embodiment of the system in FIG. 1 comprising function modules; and

FIG. 3 is a flowchart of a method for task scheduling in accordance with one embodiment.

### DETAILED DESCRIPTION OF CERTAIN INVENTIVE EMBODIMENTS

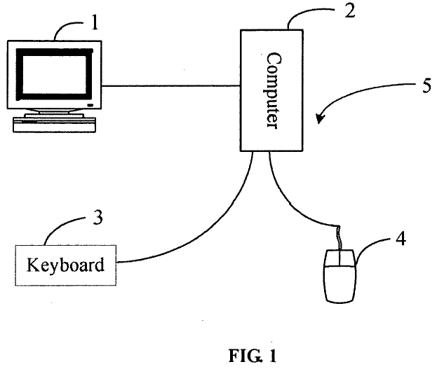

FIG. 1 is a block diagram of hardware configuration of a system 5 for task scheduling in accordance with one embodiment of the present disclosure. The system 5 may comprise a computer 2 comprising a plurality of peripherals and devices electronically connected to the computer 2. In one embodiment, the computer 2 may be electronically connected to a monitor 1, a keyboard 3, and a mouse 4 in order to input/output various computer signals or interfaces to a user. The computer 2 includes a memory, such as random access memory (RAM). In one embodiment, the computer 2 may be a personal computer (PC), a network server, and can also be any other appropriate data-processing equipment.

In one embodiment, the computer 2 may be configured for storing scheduled tasks. A scheduled task may be one of a script, a program, and/or a document to run at a scheduled time. In one exemplary embodiment of the present disclosure, the scheduled task is a script, such as an Xquery script.

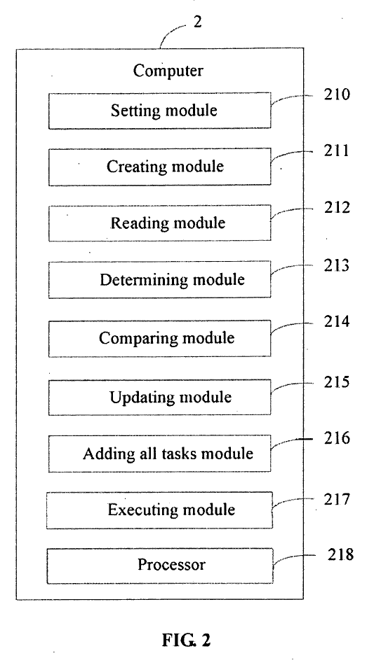

FIG. 2 is a schematic diagram of one embodiment of the system of FIG. 1 comprising function modules. In one embodiment, the computer 2 includes a setting module 210, a creating module 211, a reading module 212, a determining module 213, a comparing module 214, an updating module 215, an adding module 216, and an executing module 217.

The setting module 210 is configured for scheduling one or more scheduled tasks. For example, if users want to perform scheduled tasks like updates or maintenance during non-business hours, users can schedule one-time or recurring tasks to run at any hour of the day or night. The parameters of each of the scheduled task includes a start time, a stop time, a unique task ID, and a repeating frequency. A same unique task ID for two or more tasks indicates the scheduled tasks for the two or more tasks are identical.

The creating module 211 is configured for creating a scheduled task list which contains the one or more scheduled tasks.

The reading module 212 is configured for reading the parameters of each of the scheduled tasks including a unique task ID of each of the scheduled tasks.

The determining module 213 is configured for detecting if the memory in the computer 2 contains any current tasks.

The comparing module 214 is configured for comparing current tasks in the memory with the scheduled tasks in the scheduled task list according to the unique task IDs, if the memory contains current tasks. Tasks that are present in the memory and not present in the scheduled task lists are defined as existing tasks, and the tasks that are present in the scheduled task lists and not in the memory are defined as new tasks.

The updating module 215 is configured for adding the scheduled tasks that are present in the scheduled task lists and not in the memory into the memory, and removing the current tasks that are present in the memory and not present in the scheduled task lists according to the comparison. For example, if the memory contains tasks A and task B, the scheduled task list contain task A and task D, the updating module 215 adds the task D into the memory and removes the task B from the memory.

The adding all tasks module 216 is configured for adding all of the scheduled tasks in the scheduled tasks list into the memory, if the memory does not contain any current tasks. For example, if the memory does not contains any current tasks, the scheduled task list contain task A and task B, the adding module 216 adds the task A and task B into the memory.

The executing module 217 is configured for executing a task from the memory if it is the time to perform the task. For example, if the start time of a task for backing up the system is 11:00 PM, the executing module 217 executes the scheduled task to back up the system drive when the system time is 11:00 PM.

Additionally, the computer 2 may comprise one or more general purpose or specialized processors, such as a processor 218 for executing the setting module 210, the creating module 211, the reading module 212, the determining module, the comparing module 214, the updating module 215, the adding all tasks module 216, executing module 217 and a processor 218.

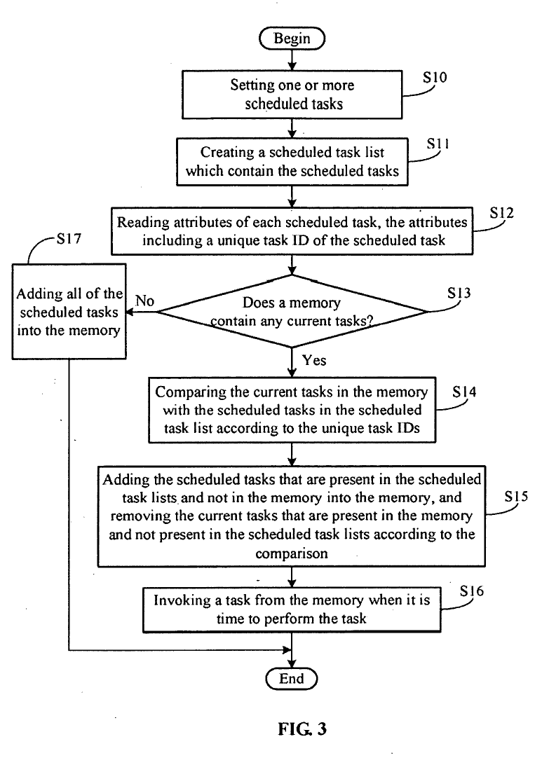

FIG. 3 is a flowchart of a method for task scheduling in accordance with one embodiment of the present disclosure. Depending on the embodiment, additional blocks may be added, others removed, and the ordering of the blocks may be changed.

In block S10, the setting module 10 schedules one or more scheduled tasks. For example, if users want to perform scheduled tasks like updates or maintenance during non-business hours, users can schedule one-time or recurring tasks to run at any hour of the day or night. The parameters of each of the scheduled task includes a start time, a stop time, a unique task ID, a repeating frequency. A same unique task ID for two or more tasks indicates the scheduled tasks for the two or more tasks are identical.

In block S11, the creating module 211 creates a scheduled task list which contains the one or more scheduled tasks.

In block S12, the reading module 212 reads the parameters for each of the scheduled tasks including a unique task ID of the scheduled task.

In block S13, the determining module 213 detects if the memory in the computer 2 contains any current tasks.

If the memory contains current tasks, in block S14, the comparing module 214 compares the current tasks in the memory with the scheduled tasks in the scheduled task list according to the parameters. As mentioned above, tasks that are present in the memory and not present in the scheduled task lists are defined as existing tasks, and the tasks that are present in the scheduled task lists and not in the memory are defined as new tasks.

Otherwise, if the memory does not contain any current tasks, in block S17, the adding all tasks module 216 adds all of the scheduled tasks into the memory.

In block S15, the updating module 215 adds the scheduled tasks that are present in the scheduled task lists and not in the memory into the memory, and removes the current tasks which are present in the memory and not present in the scheduled task lists according to the comparison.

In block S16, the executing module 217 executes a task from the memory if it is the time to perform the task.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A system for task scheduling, the system comprising:
a setting module configured for scheduling one or more scheduled tasks, the one or more scheduled tasks each comprising one or more parameters, the parameters comprising a unique task ID of a scheduled task;
a creating module configured for creating a scheduled task list that comprising the one or more scheduled tasks;
a reading module configured for reading the parameters for each of the scheduled tasks;
a determining module configured for detecting if a memory of the system contains any current tasks;
a comparing module configured for comparing the current tasks in the memory with the scheduled tasks in the scheduled task list according to the unique task IDs upon the condition that the memory contains current tasks;
an updating module configured for adding the scheduled tasks in the scheduled task lists and not in the memory into the memory, and removing the current tasks that are in the memory and not present in the scheduled task lists according to the comparison; and
a processor that executes the setting module, the creating module, the reading module, the determining module, the comparing module, and the updating module.

2. The system according to claim 1, wherein each of scheduled tasks is one of a script, a program, and/or a document to run at a scheduled time.

3. The system according to claim 1, wherein the parameters further comprises a start time, a stop time and a repeating frequency.

4. The system according to claim 1, further comprising an adding all tasks module configured for adding all of the scheduled tasks in the scheduled task list into the memory upon the condition that the memory does not contain any current tasks.

5. The system according to claim 1, further comprising an executing module configured for executing a task from the memory when it is time to perform the task.

6. A computer-based method for task scheduling, the method comprising:
scheduling one or more scheduled tasks;
creating a scheduled task list containing the one or more scheduled tasks;
reading parameters for each of the scheduled tasks, the parameters comprising a unique task ID of the scheduled task;
comparing the current tasks in the memory with the scheduled tasks in the scheduled task list according to the unique task IDs upon the condition that the memory contains current tasks; and
adding the scheduled tasks that are in the scheduled task lists and not in the memory into the memory, and removing the current tasks that are in the memory and not in the scheduled task lists according to the comparison.

7. The method according to claim 6, wherein each of the scheduled tasks is one of a script, a program, and/or a document to run at a time.

8. The method according to claim 6, wherein the parameters further comprises a start time, a stop time, and a repeating frequency.

9. The method according to claim 6, further comprising:
adding all of the scheduled tasks in the scheduled task list into the memory upon the condition that the memory does not contain any current tasks.

10. The method according to claim 6, further comprising:
executing a task from the memory.
